(19) United States
(12) Patent Application Publication
(10) Pub. No.: US 2012/0255635 A1
(43) Pub. Date: Oct. 11, 2012

(54) METHOD AND APPARATUS FOR REFURBISHING GAS DISTRIBUTION PLATE SURFACES

(75) Inventors: Sumanth BANDA, San Jose, CA (US); Jennifer Y. SUN, Mountain View, CA (US); Ren-Guan DUAN, Fremont, CA (US); Thomas J. Graves, Los Altos, CA (US); Wendell G. BOYD, JR., Morgan Hill, CA (US); Randolph William DUDLEY, JR., San Jose, CA (US); Khoi DOAN, San Jose, CA (US); William M. LU, Sunnyvale, CA (US)

(73) Assignee: Applied Materials, Inc., Santa Clara, CA (US)

(21) Appl. No.: 13/442,813

(22) Filed: Apr. 9, 2012

Related U.S. Application Data
(60) Provisional application No. 61/474,235, filed on Apr. 11, 2011.

(51) Int. Cl. B32B 38/16; B24B 1/00; B32B 38/10

(52) U.S. Cl. 137/561 A; 156/153; 156/701; 451/28

(57) ABSTRACT

Embodiments described herein generally relate to methods and apparatus for refurbishing a gas distribution plate assembly utilized in a deposition chamber or etch chamber. In one embodiment, a method for refurbishing a gas distribution plate assembly is provided. The method includes urging a faceplate of a gas distribution plate assembly against a polishing pad of a polishing device, the faceplate having a plurality of gas distribution holes disposed therein, providing relative motion between the faceplate and the polishing pad, and polishing the faceplate against the polishing pad.

### CROSS-REFERENCE TO RELATED APPLICATIONS

This application claims benefit of U.S. Provisional Patent Application Serial No. 61/474,235 (Attorney Docket No. 16305L), filed Apr. 11, 2011, which application is hereby incorporated by reference herein.

### BACKGROUND

1. Field

Embodiments described herein generally relate to refurbishing surfaces of semiconductor processing chamber components, such as a gas distribution plate surface, to restore the surface to a virgin or near-virgin state.

2. Description of the Related Art

In the manufacture of electronic devices on substrates, such as semiconductor substrates, multiple processing steps are utilized. For example, deposition and etch processes are performed on the substrates. Gases are flowed to a chamber and through a gas distribution plate positioned above a substrate. A processing region is formed between the gas distribution plate and the substrate where the gases are dissociated thermally, or by formation of a plasma, to deposit or remove materials from the substrate.

During processing, the surfaces of the chamber that are in proximity to the processing zone become contaminated with deposition or etchant by-products. The contamination on the component surfaces will reach a point where process parameters are significantly affected and the surfaces will require cleaning. Conventional cleaning of the component surfaces is typically performed by manually wiping the surfaces with a solvent or an acid to remove the by-products. This method is very labor-intensive and time-consuming, which causes significant chamber downtime and cost.

Additionally, with the conventional cleaning techniques, the component surfaces may not perform the same as a new surface after cleaning. For example, the surface of a gas distribution plate that is utilized as an electrode in a plasma process typically has a specific surface roughness when new. The surface roughness contributes to the electrical characteristics of the gas distribution plate, which in turn affects processing conditions and processing results. During processing, the surface is attacked by process chemistry, which changes the surface roughness and/or creates pitting. Thus, wiping of the surface may remove by-products, but the cleaned surface has an electrical characteristic different than the original (new) gas distribution plate. Thus, the cleaned gas distribution plate will undesirably produce different processing results.

Therefore, there is a need for a method and apparatus to refurbish component surfaces in a chamber and restore the chamber component to a virgin or near virgin state.

### SUMMARY

Embodiments described herein generally relate to methods and apparatus for refurbishing a gas distribution plate surface to a virgin or near-virgin state. More particularly, to methods and apparatus for refurbishing a gas distribution plate assembly utilized in a deposition chamber or etch chamber.

In one embodiment, a method for refurbishing a gas distribution plate assembly includes urging a faceplate of a gas distribution plate assembly against a polishing pad of a polishing device, the faceplate having a plurality of gas distribution holes disposed therein, providing relative motion between the faceplate and the polishing pad, and polishing the faceplate against the polishing pad.

In another embodiment, a method for refurbishing a gas distribution plate assembly includes de-bonding a first major surface of a faceplate from a body of a gas distribution plate assembly, polishing a second major surface of the faceplate to a surface finish of about 6 μ-inch or smoother, and heat treating the polished faceplate in a vacuum environment.

In yet another embodiment, a gas distribution plate assembly is provided that include a body is coupled to a faceplate. The body has having a first plurality of gas distribution holes disposed therein. The faceplate has a second plurality of gas distribution holes disposed therein that coaxially align with the first plurality of gas distribution holes of the body. The faceplate has a thermally treated surface facing away from the body. The thermally treated surface has a surface finish of 6 μ-inch or smoother.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a cross sectional view of a conventional gas distribution plate assembly.

FIG. 1B is a schematic plan view of the gas distribution plate assembly of FIG. 1A along section line 1B-1B.

FIG. 2 is a cross-sectional view of a gas distribution plate assembly according to embodiments described herein.

FIG. 3A shows a top plan view of one embodiment of a polishing device that may be utilized in a refurbishment method to polish the gas distribution plate assembly of FIG. 2.

FIG. 3B is a top plan view of another embodiment of a polishing device that may be utilized in a refurbishment method to polish the gas distribution plate assembly of FIG. 2.

FIG. 4 is a side cross-sectional view of one embodiment of a polishing material that may be utilized as the polishing pad shown in FIG. 3B.

FIG. 5A is a graph comparing surface roughness of a surface of a gas distribution plate assembly of FIG. 2 before and after polishing.

FIG. 5B shows fluorine content of a surface of a gas distribution plate assembly before and after performing the refurbishment method as described herein.

FIG. 5C shows aluminum content of a surface of a gas distribution plate assembly before and after performing the refurbishment method as described herein.

FIG. 6A is a graph comparing etch rate (ER) of a gas distribution plate assembly that has not been polished with an etch rate utilizing a gas distribution plate after polishing.

FIG. 6B is a graph showing a comparison in etch rate with a standard break direct current (DC) condition versus a DC break short condition.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention generally relate to methods and apparatus for refurbishing a gas distribution plate assembly utilized in a deposition chamber or etch chamber. The method includes restoring a surface of the gas distribution plate assembly to a virgin or near-virgin condition. In certain embodiments, the method may be utilized on other components of deposition chambers, etch chambers or other plasma processing chambers. Embodiments described herein may be practiced on components used in an etch chamber or etch system, such as the ADVANTEDGE™ etch system available from Applied Materials, Inc., Santa Clara, Calif. It is to be understood that the embodiments discussed herein may be practiced on other components used in other processing systems, including those sold by other manufacturers.

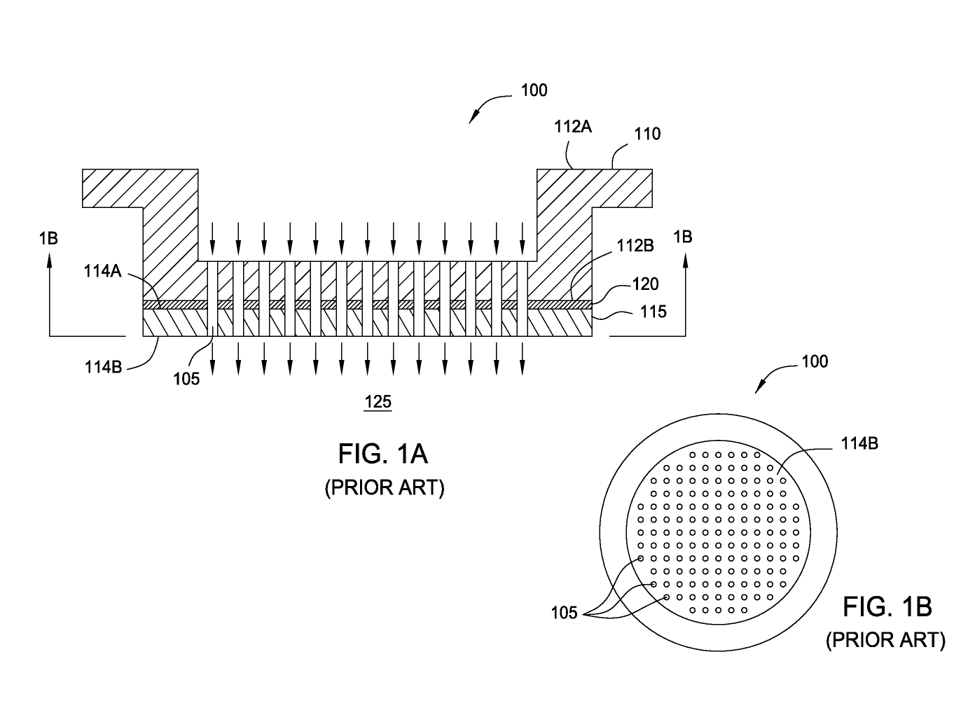

FIG. 1A is a cross sectional view of a conventional gas distribution plate assembly 100. The gas distribution plate assembly 100 may be disposed in a plasma processing chamber (not shown), such as an etch chamber, a chemical vapor deposition (CVD) chamber, a plasma enhanced chemical vapor deposition (PECVD) chamber, and the like. The gas distribution plate assembly 100 may be coupled to a radio frequency power source (not shown) to function as an electrode in the formation of plasma within the chamber. The gas distribution plate assembly 100 may be a showerhead utilized to deliver process gases though a plurality of gas distribution holes 105 in the direction of the arrows. The gas distribution holes 105 may form a pattern of rows or circular rings as shown in FIG. 1B.

Referring again to FIG. 1A, the gas distribution plate assembly 100 comprises a body 110 and a faceplate 115. The body 110 may be made of a conductive material, such as aluminum or stainless steel. The body 110 comprises a first side 112A and an opposing second side 112B. The faceplate 115 is disposed on the second side 112B of the body 110. The gas distribution holes 105 extend in alignment through both of the faceplate 115 and the body 110. The faceplate 115 may be a ceramic material, such as silicon carbide (SiC), quartz, bulk yttrium, yttrium oxide, or other process resistant material, such as aluminum. The faceplate 115 includes a first major surface 114A and a second major surface 114B opposing the first major surface 114A. The faceplate 115 may be bonded, clamped or otherwise secured to the body 110. In one embodiment, the first major surface 114A of the faceplate 115 is bonded to the second side 112B of the body 110 by an adhesive 120. It is possible that the gas distribution plate assembly 100 may be configured with the faceplate 115 and the body 110 formed from a single mass of material as a unitary, one-piece member.

The second major surface 114B of the faceplate 115 faces a processing zone 125 in the plasma processing chamber. During multiple processing cycles, the second major surface 114B becomes contaminated with processing by-products. The by-products may comprise particles that may subsequently be dislodged and contaminate the substrate. The by-products may also clog the gas distribution holes 105, which may restrict gas flow through the gas distribution plate assembly 100. The second major surface 114B is also subjected to heat, process chemistry and ion bombardment that erodes the second major surface 114B. Thus, the properties of the second major surface 114B and the operation of the gas distribution plate assembly 100 change over time and cause process drift.

For example, when the gas distribution plate assembly 100 is new, the second major surface 114B may comprise an “as designed” average surface roughness (Ra), which illustratively and not by way of limitation may be less than or equal to about 20 μ-inch. In an etch process, the etchant chemistry and ions attack the second major surface 114B, causing the second major surface 114B to become rougher. In one example, the average surface roughness of the second major surface 114B may increase to an RA of about 30 μ-inch to about 1,000 μ-inch after multiple processing cycles. The change in roughness of the second major surface 114B may cause process drift in plasma application as the roughness of the second major surface 114B affects the electrical characteristics of the plasma. The change in plasma characteristics is detrimental as the different plasma characteristics cause a drift in etch rate. The drift in etch rate may cause wafer to wafer non-uniformity as well as within-wafer non-uniformity. The non-uniformity significantly affects throughput of the chamber.

While wiping the second major surface 114B may remove by-products from the second major surface 114B, the wiping does not remove excessive roughness of the second major surface 114B. The inventors have discovered a refurbishment process whereby the second major surface 114B may be cleaned to remove any by-products and restore the second major surface 114B to a surface roughness (e.g., Ra) that is equal to a new or unused gas distribution plate. The refurbishment process restores the second major surface 114B of the gas distribution plate assembly 100 to a virgin or near virgin state to substantially eliminate process drift. Moreover, the refurbishment method substantially eliminates variation between gas distribution plate assemblies, thus reducing variation between products that are fabricated using different gas distribution plate assemblies.

When the gas distribution plate assembly 100 is removed from the chamber, the gas distribution plate assembly 100 may be prepared for refurbishment. In one embodiment, at least the second major surface 114B of the faceplate 115 is planarized or polished in a refurbishment process. In some embodiments, the faceplate 115 is removed from the body 110 of the gas distribution plate assembly 100 to undergo the refurbishment process. In other embodiments, the gas distribution plate assembly 100 and the faceplate 115 are refurbished as an integral unit. In some embodiments, the gas distribution holes 105 are blocked to prevent polishing debris from entering the gas distribution holes 105. In one embodiment, the gas distribution holes 105 are blocked with a solid material. In other embodiments, a compressed gas, a pressurized fluid, or combinations thereof, is provided to or flowed through the gas distribution holes 105. After polishing, the faceplate 115 and/or the gas distribution plate assembly 100 is cleaned to remove residual polishing debris, heat treated, baked out, and prepared for shipping.

In one embodiment of a refurbishment process, the faceplate 115 is removed from the body 110 by a de-bonding procedure which may comprise removing the adhesive 120. The de-bonding procedure may be chemical or thermal. Chemical de-bonding allows for the same body 110 to be reaffixed to the faceplate 115 after the refurbishment process. Thermal de-bonding often damages the body 110 during removal of the faceplate 115, such that the original body 110 id discarded and a new body 110 is affixed to the faceplate 115 after the refurbishment process. The faceplate 115 maybe cleaned after de-bonding using an acid bath, for example, an HF bath.

The faceplate 115 may be processed in a polishing device that removes material from the second major surface 114B. The polishing device may be grinding tool, a chemical mechanical polisher, a lapping tool or other tool suitable for obtaining a desired surface finish (RA) as discussed below. In one embodiment, one or both of the first major surface 114A and the second major surface 114B of the faceplate 115 may be polished in the polishing device. For example, the second major surface 114B of the faceplate 115 may be urged against a polishing surface of the polishing device in the presence of a slurry and/or de-ionized water (DIW) to remove by-products and planarize the second major surface 114B to a desired Ra. The first major surface 114A of the faceplate 115 may also be planarized to prepare the first major surface 114A for re-bonding to the second side 112B of the body 110 of the gas distribution plate assembly 100. The polishing device, as further discussed below, may be adapted to produce a profile on the second major surface 114B of the faceplate 115 that is one of planar, concave or convex.

In one embodiment, the second major surface 114B of the faceplate 115 is polished to a desired Ra. In one embodiment, the polishing process removes about 25 microns (pm) to about 50 μm of material from the faceplate 115. In another embodiment, the polishing process removes up to about 254 μm or more of material from the faceplate 115. While the polishing endpoint of the faceplate 115 may be timed, the endpoint is typically dependent on the desired finish of the second major surface 114B in one embodiment. Thus, material removed from the faceplate 115 may be dependent on the desired finish as well as any non-planarity that is desired in the second major surface 114B. In one embodiment, the desired finish of the second major surface 114B (i.e., surface RA) is less than about 20 μ-inch. In one embodiment, the desired finish of the second major surface 114B (i.e., surface RA) is about 10 μ-inch or smoother. It has been found that the second major surface 114B has better particle performance when the surface RA is about 6 μ-inch or smoother, such as about 4 μ-inch or smoother.

After one or both of the first major surface 114A and the second major surface 114B of the faceplate 115 are polished to a desired Ra and/or flatness, the faceplate 115 may be cleaned. The faceplate 115 may be cleaned using one or more of solvents, an acid bath, power washing and/or washing with DIW. The second side 112B of the body 110 of the gas distribution plate assembly 100 may be cleaned to remove any residual adhesive 120 that remains from the de-bonding procedure. In one embodiment, the faceplate 115 is cleaned after polishing to in an acid bath, for example, an HF bath. The body 110 of the gas distribution plate assembly 100 may be also be cleaned using one or more of solvents, acid bath power washing and/or washing with DIW.

Prior to re-bonded the faceplate 115 to the second side 112B of the body 110, the faceplate 115 is heat treated. In one embodiment, the faceplate 115 is heat treated is a vacuum furnace. The vacuum furnace temperatures may range from about 1200 to about 1300 degrees Celsius during the heat treating of the faceplate 115. It has been found that by heat treating faceplate 115 comprised for SiC, a significant reduction in particle shedding is obtained. It is believed that the reduction in particle shedding is due a restoration of the surface morphology of the faceplate from a state altered due to polishing back to a condition similar to that of a virgin SiC surface. Even after heat treating, polishing and removing a significant amount of material from the faceplate 115, the faceplate 115 still will exhibit evidence of plasma exposure as all of the pitting cannot be removed even through the surface morphology of the faceplate 115 has been restored.

After heat treating, the faceplate 115 may be cleaned using an acid bath, such as an HF bath. The faceplate 115 may be cleaned using ultrasonic excitation.

The faceplate 115 may then be re-bonded to the second side 112B of the body 110. The body 110 with the refurbished faceplate 115 attached may then be further cleaned using one or a combination of power washing and rinsing with DIW to remove any residual polishing by-products that may be present in the body 110 and the faceplate 115 of the gas distribution plate assembly 100. The gas distribution plate assembly 100 with the refurbished faceplate 115 may then be baked out and packaged for shipping.

In another embodiment of a refurbishment process, the faceplate 115 and the body 110 of the gas distribution plate assembly 100 are refurbished as an integral unit. Polishing the faceplate 115 with the body 110 attached does not require de-bonding, and reduces the cost of the refurbishment method by about 60%. The body 110 of the gas distribution plate assembly 100 is coupled to a polishing device such that the second major surface 114B of the faceplate 115 is facing the polishing surface of the polishing device. In one embodiment, a slurry and/or DIW is provided to the polishing surface of the polishing device. In one aspect, the slurry and/or DIW is utilized to enhance removal of material from the second major surface 114B of the faceplate 115. In another aspect, the slurry and/or DIW is flowed to the polishing surface of the polishing pad through the gas distribution holes 105 of the gas distribution plate assembly 100, which may prevent clogging of the gas distribution holes 105. In another embodiment, a blocker material is used to prevent slurry and/or polishing by-products from entering the gas distribution holes 105.

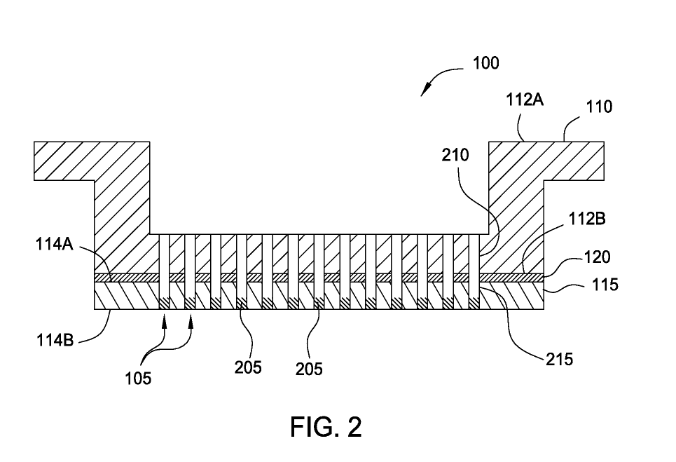

FIG. 2 shows a gas distribution plate assembly 100 that has been used and is ready for refurbishment. The gas distribution plate assembly 100 shown in FIG. 2 is similar to the gas distribution plate assembly 100 shown in FIG. 1A with the exception of a blocker material 205 disposed in at least a portion of the gas distribution holes 105 exiting the faceplate 115 at the second major surface 114B. Additionally, the surface roughness (RA) of the second major surface of the gas distribution plate assembly 100 may be about 30 μ-inch to about 1,000 μ-inch, or greater, due to erosion from processing. The gas distribution holes 105 may comprise a first plurality of gas distribution holes 210 formed in the body 110 and a second plurality of gas distribution holes 215 formed in the faceplate 115. In one embodiment, the first plurality of gas distribution holes 210 substantially coaxially align with the second plurality of gas distribution holes 215 when the faceplate 115 is coupled to the body 110. The blocker material 205 is utilized to at least partially fill the gas distribution holes 105 to prevent flow of fluids, processing by-products and slurry from entering the gas distribution holes 105 from the second major surface 114B. The blocker material 205 may be any material that is substantially resistant to slurry chemistry and/or DIW that may be present during the polishing process. The blocker material 205 should also be a material that is easily removed after the polishing process. In one embodiment, the blocker material 205 is a curable emulsion that is soluble with water or a chemical solvent. In one embodiment, the blocker material is a resist emulsion, for example, SBX™ liquid resist emulsion available from IKONICS® Corp. of Duluth, Minn., USA.

In one embodiment, the method of polishing a faceplate 115 without having the slurry entering the gas distribution holes 105 of the faceplate 115 and/or the gas distribution plate assembly 100 comprises applying the blocker material 205 to squeegee the liquid emulsion or blocker inside the gas distribution holes 105, as shown in FIG. 2. The blocker material 205 may be applied to the gas distribution holes 105 on the second major surface 114B of the faceplate 115 when the second major surface 114B of the faceplate 115 is to be polished. In another embodiment (not shown), the blocker material 205 may be applied to both of the first major surface 114A and the second major surface 114B of the faceplate 115 when both sides of the faceplate 115 are to be polished.

The blocker material 205 may be applied using a mechanical means or manual means. In one embodiment, an applicator machine can be utilized to dispense the liquid blocker material 205 into the gas distribution holes 105 in very precise and controlled amount. In another embodiment, a machine utilizing a squeegee can be used to apply the liquid blocker material 205. The blocker material 205 can also be manually squeegeed into the gas distribution holes 105.

After application of the blocker material 205 to the surface(s) of the faceplate 115, excess liquid blocker material 205 that remains on the surface(s) may be wiped off. DIW may be utilized to remove the excess blocker material 205. In some embodiments, the blocker material 205 may be cured with ultra-violet (UV) light or heat. Thus, the excess liquid blocker material 205 that remains on the surface(s) should be washed and/or wiped prior to exposure to curing. When the blocker material 205 hardens, the faceplate 115 may be polished.

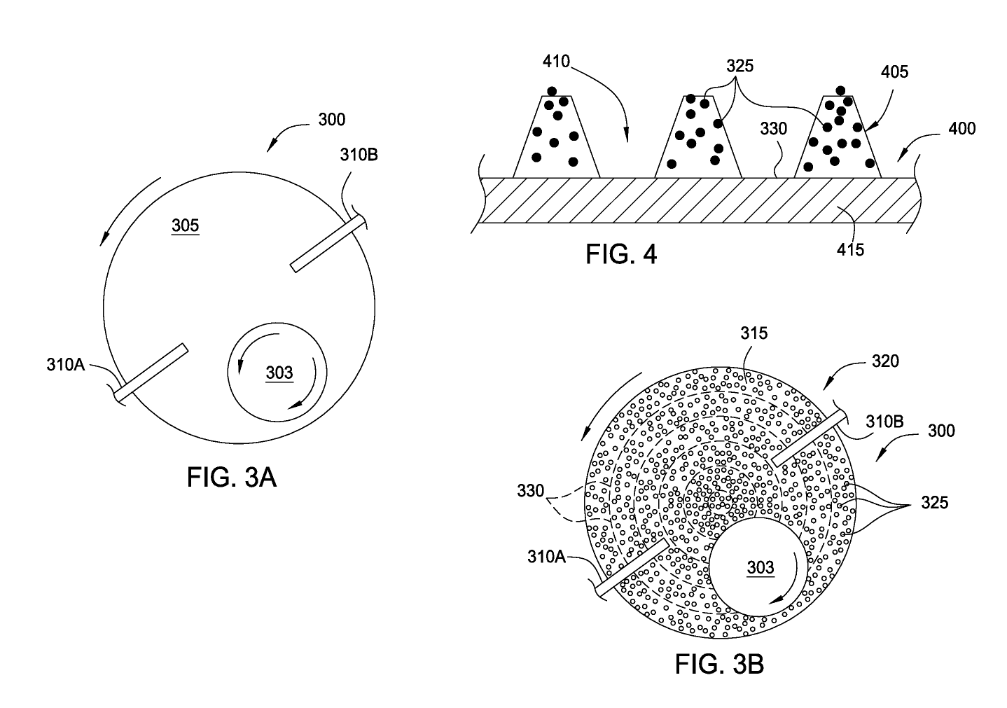

FIG. 3A shows a top plan view of one embodiment of a polishing device 300 that may be utilized in a refurbishment method to polish the faceplate 115. The polishing device 300 may be a lapping machine or chemical mechanical polisher. A substrate 303 is shown in FIG. 3A disposed above a polishing pad 305 of the polishing device 300. In the top plan view shown in FIG. 3A, the substrate 303 may be either of the first major surface 114A or the second major surface 114B of the faceplate 115, or the first side 112A of the body 110 of the gas distribution plate assembly 100. The polishing device 300 may be a conventional polishing apparatus having a rotatable platen supporting the polishing pad 305, a motor to rotate the platen, a fluid delivery devices 310A, 310B. While a polishing device 300 utilizing a circular polishing pad is shown, other polishing devices, such as linear belts and web systems may also be utilized. The polishing pad 305 may comprise a polymeric material, such as polyurethane, polycarbonate, fluoropolymers, PTFE, PTFA, polyphenylene sulfide (PPS), or combinations thereof, and other polishing materials used in polishing substrate surfaces.

Regardless if the substrate 303 is the faceplate 115 alone, or the gas distribution plate assembly 100 and the faceplate 115 together, the surface of the substrate 303 is positioned such that the surface to be polished (i.e., the first major surface 114A or the second major surface 114B of the faceplate 115 (not shown in this view)) contacts the polishing pad 305. The substrate 303 may be coupled to a carrier device (not shown) that holds the substrate 303 in a position adjacent the polishing pad 305. The carrier device may also be motorized to facilitate rotation of the substrate 303. The carrier device may also be coupled to an actuator to provide a controllable down force to the substrate 303 such that the substrate 303 may be controllably urged against the polishing pad 305. Additionally, the carrier device may be adapted to move the substrate 303 laterally relative to the polishing pad 305 in a linear or arcing motion.

To remove material from the substrate 303, the polishing pad 305 may be rotated in a first direction, such as counter clockwise as shown by the arrow. The substrate 303 may be rotated in a second direction, which may be counter clockwise or clockwise. In one embodiment, the polishing pad 305 is rotated in the first direction while the substrate 303 is rotated in the second direction which is opposite of the first direction. During polishing, a chemical composition, such as a slurry or other polishing compound with or without entrained abrasives, may be provided to the polishing pad 305 by the fluid delivery device 310A. Additionally or alternatively, de-ionized water (DIW) may be provided to the polishing pad 305 by the fluid delivery device 310B. In embodiments where the blocker material 205 is not utilized, the slurry and/or the DIW may be applied to the polishing pad 305 through the gas distribution holes 105 to prevent polishing debris from entering the gas distribution holes 105. Alternatively or additionally, air or other gases may be flowed through the gas distribution holes 105 to prevent polishing debris from entering the gas distribution holes 105.

FIG. 3B is a top plan view of another embodiment of a polishing device 300 having a polishing pad 315 that may be utilized in a refurbishment method to polish the substrate 303. In the top plan view shown in FIG. 3B, the substrate 303 may be either of the first major surface 114A or the second major surface 114B of the faceplate 115, or the first side 112A of the body 110 of the gas distribution plate assembly 100. The polishing device 300 includes a carrier device (not shown) as described in FIG. 3A that holds the substrate 303 against the polishing pad 315. The surface of the substrate 303 is positioned such that the surface to be polished (i.e., the first major surface 114A or the second major surface 114B of the faceplate 115 (not shown in this view)) contacts the polishing pad 315, as described in FIG. 3A.

The polishing pad 315 in this embodiment includes a plurality of abrasive particles 325 dispersed in a polishing surface of the polishing pad 315. The abrasive particles 325 may be ceramic particles, diamond particles, or combinations thereof. The polishing pad 315 may also include grooves 330 to assist in removing polishing by-products and debris from the polishing surface of the polishing pad 315. In one embodiment, the polishing pad 315 comprises a polishing pad marketed under the name TRIZACT™, which is available from 3M® Company of St. Paul, Minn., USA, although other polishing pads having abrasive particles and/or grooved surfaces may be utilized. The polishing pad 315 may be conditioned with a conditioner device 320 before polishing the substrate 303. The conditioner device 320 includes an abrasive disk which works and/or removes a portion of the surface of the polishing pad 315 to expose the abrasive particles 325. The abrasive particles 325 assist in removing material from the surface of the substrate 303 to be polished (i.e., the first major surface 114A or the second major surface 114B of the faceplate 115 (not shown in this view)).

FIG. 4 is a side cross-sectional view of one embodiment of a polishing material 400 that may be utilized as the polishing pad 315 shown in FIG. 3B. The polishing material 400 comprises a plurality of raised features 405 formed between channels 410. The channels 410 may intersect with the grooves 330 such that the raised features 405 are arranged in a grid. The raised features 405 have abrasive particles 325 disposed therein. In one embodiment, the abrasive particles 325 are diamond particles. The diamond particles may be of a specific sizing or include combinations of diamond grit sizes. For example, the diamond size may be A300, A160, A80, A45, A30, A20, A10, A6, A5, A3 or combinations thereof. The raised features 405 may be coupled to a backing material 415 that provides mechanical strength to the raised features 405. The configuration of the channels 410 and/or the groove 330 formed in the polishing material 400 may assist in polishing debris removal as the debris is flushed away by fluid flowing in the channels 410 and/or the grooves 330. In this manner, polishing debris is readily removed from the surface of the polishing material 400 and is not forced into the gas distribution holes 105 of the faceplate 115. When the blocker material 205 is utilized, the channels 410 and/or the grooves 330 allow slurry and polishing debris to readily flow out from under the substrate 303 without causing the substrate 303 to lift away from the polishing material 400.

During polishing, the polishing surface of the polishing pad 315 may be conditioned to refresh the polishing surface and expose abrasive particles 325. Slurry or DIW may be provided to the polishing pad 315 by the fluid delivery device 310A to assist in removing polishing debris from the polishing surface of the polishing pad 315. In embodiments where the blocker material 205 is not utilized, fluid(s) may be applied to the polishing pad 315 through the gas distribution holes 105 to prevent polishing debris from entering the gas distribution holes 105. Suitable fluids include DIW, nitrogen, air or other gases.

The faceplate 115 may be polished in the polishing device 300 using the polishing pad 305 or the polishing pad 315 as described in FIGS. 2A and 2B. In embodiments where the second major surface 114B of the faceplate 115 is to be polished, the second major surface 114B may be so distorted from exposure to heat and/or etchant chemicals that the second major surface 114B may not be flat. In the instance where the second major surface 114B is not planar, the polishing pad 305 or 315 may need to be shimmed to ensure the entirety of the second major surface 114B of the faceplate 115 is in contact with the polishing pad 305 or 315. The polishing pad 305 or 315 may also be shimmed in a manner that produces a planar, concave or convex surface on at least the second major surface 114B of the faceplate 115. Shimming may be employed after a portion of the polishing process is complete. The location of the shims may be determined through visual inspection of the substrate 303 to compensate for areas that are not being polished effectively.

In one embodiment, the polishing of the faceplate 115 may be timed and/or determined according to a desired Ra of the first major surface 114A and/or the second major surface 114B of the faceplate 115. In one embodiment, the polishing process removes about 25 microns (pm) to about 50 μm of material from the faceplate 115. In another embodiment, the polishing process removes up to about 254 μm or more of material from the faceplate 115. While the polishing endpoint of the faceplate 115 may be timed, the endpoint is typically dependent on the desired finish of the second major surface 114B in one embodiment. Thus, material removed from the faceplate 115 may be dependent on the desired finish as well as any non-planarity that is desired in the second major surface 114B. In one embodiment, the desired finish of the second major surface 114B (i.e., surface RA) is less than about 20 μ-inch. In one embodiment, the desired finish of the second major surface 114B (i.e., surface RA) is about 10 μ-inch or smoother. It has been found that the second major surface 114B has better particle performance when the surface RA is about 6 μ-inch or smoother, such as about 4 μ-inch or smoother.

After polishing, the faceplate 115 may be cleaned. When the blocker material 205 is utilized to fill the gas distribution holes 105 of the faceplate 115, the blocker material 205 must be removed. To remove the blocker material 205 in the gas distribution holes 105, a remover is utilized. When the faceplate 115 is polished alone, or when the body 110 of the gas distribution plate assembly 100 is attached to the faceplate 115 during polishing, the faceplate 115, or the faceplate 115 and the body 110 of the gas distribution plate assembly 100 are soaked in the remover. The soak process may take several hours. Suitable removers may be acetone or other suitable solvents or strippers. A commercially available remover is available from IKONICS® Corp. of Duluth, Minn., USA. When the blocker material 205 is water soluble, water is used as the remover.

The faceplate 115 may be power washed after the soak process. Power washing may be performed by applying pressurized DIW to at least the second major surface 114B of the faceplate 115 to remove blocker material 205 from the gas distribution holes 105. The pressurized DIW is used to purge the gas distribution holes 105 to remove any remaining blocker material 205. Additionally, several soaking and purging cycles may need to be performed before the gas distribution holes 105 are completely cleaned of residual blocker material 205.

Prior to reading the gas distribution plate assembly 100 for shipping, the faceplate 115 is heat treated. In one embodiment, the faceplate 115 is heat treated is a vacuum furnace. The vacuum furnace temperatures may range from about 1200 to about 1300 degrees Celsius during the heat treating of the faceplate 115. It has been found that by heat treating faceplate 115 comprised for SiC, a significant reduction in particle shedding is obtained. It is believed that the reduction in particle shedding is due a restoration of the surface morphology of the faceplate from a state altered due to polishing back to a condition similar to that of a virgin SiC surface.

After heat treating, the gas distribution plate assembly 100 is readied for shipping. When the body 110 of the gas distribution plate assembly 100 is attached to the faceplate 115 for the polishing process, the gas distribution plate assembly 100 is fully cleaned after power washing and may be baked out and packaged. When the faceplate 115 is polished alone, the second side 112B of the body 110 may be prepared for coupling to the faceplate 115. New adhesive 120 is applied between the second side 112B of the body 110 and the first major surface 114A of the faceplate 115 to facilitate bonding. After bonding, the gas distribution plate assembly 100 may be baked out and packaged for shipping.

The embodiments of the refurbishment method as described herein substantially restores the second major surface 114B to a surface roughness equal to that of a new gas distribution plate. The second major surface 114B is within specification after the refurbishment method and includes a surface roughness of about 20 Ra or less, in one embodiment. Additionally, deposition, cleaning or etch by-products that may cause particle contamination, such as AIFₓ, are removed from the faceplate 115 during polishing, thereby eliminating the need to manually wipe the gas distribution plate assembly 100. Thus, the refurbished gas distribution plate assembly 100 may be installed into a chamber and the electrical characteristics of the gas distribution plate assembly 100 may perform as though the gas distribution plate assembly 100 is new.

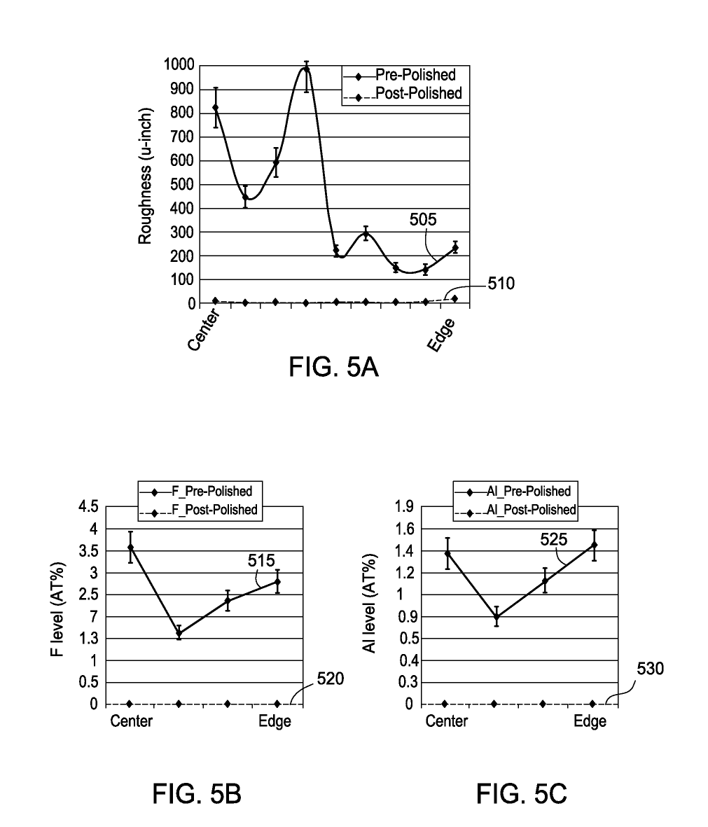

FIG. 5A is a graph comparing surface roughness of the second major surface 114B before and after polishing of the faceplate 115. Line 505 is the surface roughness (in μm) of the second major surface 114B prior to performing the refurbishment method as described herein. Line 510 is the surface roughness (in μm) of the second major surface 114B after the gas distribution plate assembly 100 has been refurbished as described herein.

FIGS. 5B and 5C are graphs showing chemistry contamination results of the second major surface 114B before the refurbishment method and after the refurbishment method as described herein. FIG. 5B shows the fluorine content before performing the refurbishment method at line 515 and the fluorine content after performing the refurbishment method at line 520. FIG. 5C shows the aluminum content before performing the refurbishment method at line 525 and the aluminum content after performing the refurbishment method at line 530. As shown, the second major surface 114B did not include any fluorine or aluminum elements, only silicon and carbon elements.

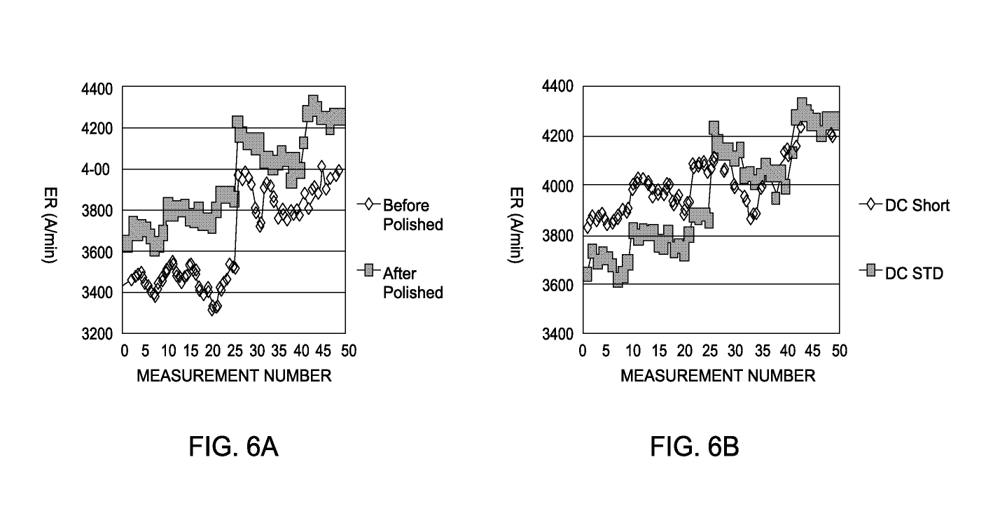

FIG. 6A is a graph comparing the etch rate (ER) of a gas distribution plate that has not been polished with an etch rate utilizing a gas distribution plate after polishing. FIG. 6B is a graph showing the etch rate (ER) using a gas distribution plate that has been refurbished according to embodiments described herein. FIG. 6B shows a comparison in etch rate with a standard break direct current (DC) condition versus a DC break short condition. The etch rate increased from 3772 angstroms per min (Å/min) to 4022 Å/min in the DC break short condition.

Embodiments described herein substantially restores the second major surface 114B of the faceplate 115 to a surface roughness equal to that of a new gas distribution plate. Additionally, deposition, cleaning or etch by-products that may cause particle contamination, such as AIF_{X}, are completely removed from the faceplate 115. The refurbishment method completely changes the surface morphology to look like new material and is uniform from center to edge. Thus, the refurbished gas distribution plate assembly 100 may be installed into a chamber and the electrical characteristics of the gas distribution plate assembly 100 may perform as though the gas distribution plate assembly 100 is new.

While the foregoing is directed to embodiments of the invention, other and further embodiments of the invention may be devised without departing from the basic scope thereof.

We claim:

1. A method for refurbishing a gas distribution plate assembly, comprising:
urging a faceplate of a gas distribution plate assembly against a polishing pad of a polishing device, the faceplate having a plurality of gas distribution holes disposed therein;
providing relative motion between the faceplate and the polishing pad; and
polishing the faceplate against the polishing pad.

2. The method of claim 1, further comprising:
filling the gas distribution holes with a blocker material.

3. The method of claim 1, further comprising:
flowing a fluid through the plurality of gas distribution holes in a direction toward the polishing pad during polishing.

4. The method of claim 2, wherein the blocker material is cured prior to polishing.

5. The method of claim 1, wherein the faceplate is coupled to a body of the gas distribution plate assembly during polishing.

6. The method of claim 2, further comprising:
removing the blocker material after polishing by exposing the blocker material to a solvent.

7. The method of claim 6, further comprising:
bonding the faceplate to a body of the gas distribution plate assembly after cleaning.

8. The method of claim 1, further comprising:
heat treating the polished substrate.

9. A method for refurbishing a gas distribution plate assembly, comprising:
de-bonding a first major surface of a faceplate from a body of a gas distribution plate assembly;
polishing a second major surface of the faceplate to a surface finish of about 6 μ-inch or smoother; and
heat treating the polished faceplate in a vacuum environment.

10. The method of claim 9, wherein heat treating further comprises:
heating the faceplace to about 1200 to about 1300 degrees Celsius.

11. The method of claim 9, further comprising:
filling a plurality of gas distribution holes in the faceplate with a blocker material; and
curing the blocker material disposed in the plurality of gas distribution holes.

12. The method of claim 11, further comprising:
dissolving the blocker material with a solvent after polishing.

13. The method of claim 10, wherein the blocker material is applied on the first major surface and the second major surface of the faceplate.

14. The method of claim 9, further comprising:
cleaning the polished faceplate in an acid bath prior to heat treating.

15. The method of claim 9, wherein de-bonding further comprises:
chemically de-bonding the faceplate from the body.

16. The method of claim 15, further comprising:
bonding the first major surface of the faceplate to the body of the gas distribution plate assembly after cleaning.

17. A gas distribution plate assembly, comprising:
a body having a first side and a second side, the body having a first plurality of gas distribution holes disposed therein;
a faceplate coupled to the second side of the body, the faceplate having a second plurality of gas distribution holes disposed therein that coaxially align with the first plurality of gas distribution holes in the body, the faceplate having a thermally treated surface facing away from the body, the thermally treated surface having a surface finish of 6 μ-inch or smoother.

18. The gas distribution plate assembly of claim 17, wherein the thermally treated surface has a surface finish of 4 μ-inch or smoother.

19. The gas distribution plate assembly of claim 17, wherein the thermally treated surface has evidence of plasma exposure.

20. A gas distribution plate assembly, comprising:
the faceplate of claim 9 bonded to an aluminum body, the aluminum body and faceplate having aligned gas distribution holes.
